(19) United States
(12) Patent Application Publication
(10) Pub. No.: US 2012/0055517 A1
(43) Pub. Date: Mar. 8, 2012

(54) Dishwasher and a control method the same

(76) Inventors: Byungkook Yoo, Seoul (KR); Somi Yang, Seoul (KR); Minwoo Choi, Seoul (KR)

(21) Appl. No.: 13/137,572

(22) Filed: Aug. 26, 2011

(30) Foreign Application Priority Data
Sep. 2, 2010 (KR) 10-2010-0086209
Sep. 2, 2010 (KR) 10-2010-0086210
Sep. 2, 2010 (KR) 10-2010-0086211

(51) Int. Cl. A47L 15/14; A47L 15/44; A47L 15/46; B08B 3/02

(52) U.S. Cl. 134/105

(57) ABSTRACT

Provided is a dishwasher, which includes a washing space, a sump, a water supply device, a heater, a control part. The washing space includes a rack accommodating a dish, and a nozzle for spraying washing water. The sump collects the washing water supplied to the washing space. The water supply device supplies the washing water to the sump. The heater is in the sump and heats the washing water. The control part controls a washing process where washing water including a detergent is sprayed toward the dish, and a rinsing process where the dish is rinsed after the washing process. The rinsing process includes a first rinsing operation where the washing water stored in the sump is sprayed to the nozzle after the washing process, a second rinsing operation where the washing water heated by the heater is sprayed through the nozzle after the first rinsing operation, and a third rinsing operation where the washing water in the sump is sprayed through the nozzle after the second rinsing operation.

### CROSS-REFERENCE TO RELATED APPLICATIONS

The present application claims priority under 35 U.S.C. 119 and 35 U.S.C. 365 to Korean Patent Application No. 10-2010-0086211, 10-2010-0086209 and 10-2010-0086210 filed on Sep. 2, 2010, which is hereby incorporated by reference in its entirety.

### BACKGROUND

The present disclosure relates to a dishwasher.

Dishwashers spray high pressure washing water to a dish through a washing nozzle, thereby removing leftover food or food waste from the dish.

Such a dishwasher includes: a washing chamber providing a space for washing a dish; a sump disposed under the washing chamber to store and supply washing water to the washing chamber; and a washing nozzle disposed in the washing chamber to spray high pressure washing water.

Washing water is supplied to the sump, and is sprayed at high pressure through the washing nozzle into the washing chamber providing the space for washing a dish.

The washing water sprayed into the washing chamber washes dishes in the washing chamber, and then, is recovered to the sump. Then, a foreign substance is filtered from the recovered washing water by a filter device disposed in the sump, and the washing water is supplied again to the washing nozzle.

As such, supplied washing water is moved to the sump and the washing nozzle in the washing chamber until the washing of the dishes is completed, and the washing water and a foreign substance filtered by the filter device are discharged out of the dishwasher to complete the washing of the dishes.

After that, a drying process may be performed to dry the washed dishes.

### SUMMARY

Embodiments provide a method of controlling a dishwasher in which, after a rinsing process for a dish, before used washing water is discharged, when a sump heater is stopped, a rinsing operation is additionally performed.

In one embodiment, a dishwasher includes: a washing space including a rack accommodating a dish, and a nozzle for spraying washing water; a sump collecting the washing water supplied to the washing space; a water supply device supplying the washing water to the sump; a heater disposed in the sump and heating the washing water; and a control part controlling a washing process in which washing water including a detergent is sprayed toward the dish, and a rinsing process in which the dish is rinsed after the washing process, wherein the rinsing process includes: a first rinsing operation in which the washing water stored in the sump is sprayed to the nozzle after the washing process; a second rinsing operation in which the washing water heated by the heater is sprayed through the nozzle after the first rinsing operation; and a third rinsing operation in which the washing water stored in the sump is sprayed through the nozzle after the second rinsing operation.

In another embodiment, a dishwasher includes: a washing chamber forming an accommodation space for a dish; a sump disposed under the washing chamber and including a washing water pump that is selectively driven according to a washing process or a rinsing process; a water supply device for supplying washing water circulating through the washing chamber and the sump; a water softener including an ionized resin to soften the washing water supplied by the water supply device; a steaming device for generating steam from the washing water softened by the water softener; and a nozzle device for spraying soft water from the sump into the washing chamber, wherein the rinsing process includes: a hot rinsing operation in which the soft water is heated to supply the washing chamber; and a cold rinsing operation in which the soft water is additionally supplied to the washing chamber after the hot rinsing operation before discharging the soft water from the sump.

The details of one or more embodiments are set forth in the accompanying drawings and the description below. Other features will be apparent from the description and drawings, and from the claims.

### BRIEF DESCRIPTION OF THE DRAWINGS

FIG. 1 is a perspective view illustrating a dishwasher according to a first embodiment.

FIG. 2 is a perspective view illustrating a state in which a door of the dishwasher is opened according to the first embodiment.

FIG. 3 is a cross-sectional view illustrating the dishwasher according to the first embodiment.

FIG. 4 is a bottom view illustrating a sump according to the first embodiment.

FIG. 5 is a cross-sectional view illustrating the sump according to the first embodiment.

FIG. 6 is a graph illustrating a temperature variation of washing water with time according to processes of the dishwasher according to the first embodiment.

FIG. 7 is a flowchart illustrating a method of controlling the dishwasher according to the first embodiment.

FIG. 8 is a cross-sectional view illustrating a dishwasher according to a second embodiment.

FIG. 9 is a plan view illustrating a state in which a washing chamber is removed from the dishwasher, according to the second embodiment.

FIG. 10 is a block diagram illustrating passages of the dishwasher according to the second embodiment.

FIG. 11 is a table illustrating process conditions of a dishwasher according to a third embodiment.

### DETAILED DESCRIPTION OF THE EMBODIMENTS

Reference will now be made in detail to the embodiments of the present disclosure, examples of which are illustrated in the accompanying drawings.

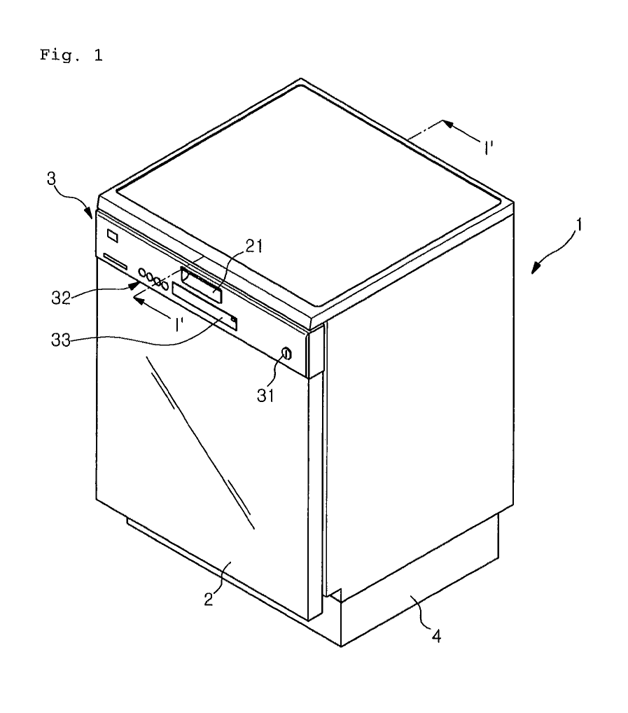

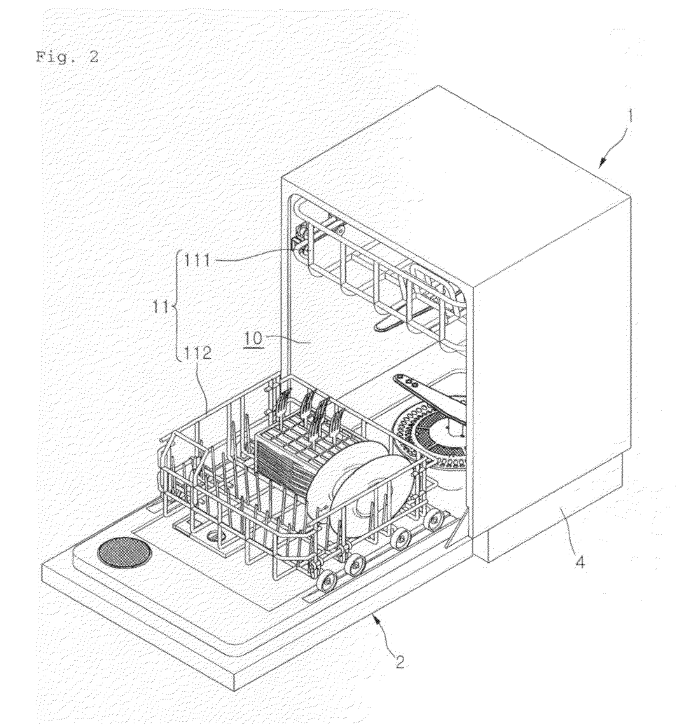

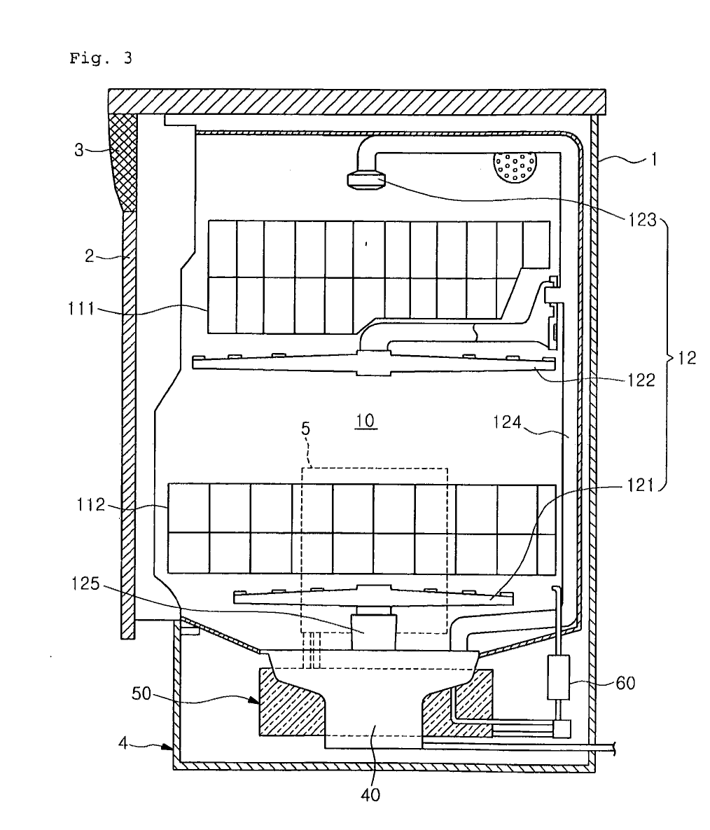

FIG. 1 is a perspective view illustrating a dishwasher according to a first embodiment. FIG. 2 is a perspective view illustrating a state in which a door of the dishwasher is opened according to the first embodiment. FIG. 3 is a cross-sectional view illustrating the dishwasher according to the first embodiment.

Referring to FIGS. 1 to 3, the dishwasher includes a main body 1 having a predetermined inner space in a rectangular parallelepiped shape. The main body 1 forms an appearance of the dishwasher.

The front side of the main body 1 is provided with a washing chamber 10 disposed in the inner space of the main body 1, and a door 2 for selectively opening and closing a front opening of the washing chamber 10. The door 2 is coupled to the main body 1 through a hinge, and is rotatable about the lower end of the main body 1. The front surface of the door 2 is provided with a door handle 21 held by a user, so that the user can rotate the door 2.

The front top of the door 2 is provided with a control panel 3 that displays an operation state of the main body 1, and that is used for a user to control the overall operation of the main body 1. The control panel 3 is provided with a power switch 31 for turning the main body 1 on and off, a manipulation part 32 manipulated for operating the main body 1, and a display part 33 displaying states of the main body 1. Alternatively, the control panel 3 may be disposed on the top surface of the main body 1.

A command recognized at the control panel 3 is transmitted to a control part of the dishwasher. The control part controls an operation of the dishwasher, based on the command.

An inner space of the door 2 is provided with a detergent storage for storing a detergent, and a rinse storage for storing a rinse. The rear surface of the door 2 is provided with a detergent inlet for introducing the detergent, and a rinse inlet for introducing the rinse. The detergent is discharged into the washing chamber 10 to perform a washing operation, and the rinse is discharged into the washing chamber 10 to perform a rinsing process.

The washing chamber 10 is disposed in the main body 1, so that dishes can be washed therein. Racks 11 are disposed in the washing chamber 10 to accommodate dishes. The racks 11 include an upper rack 111 and a lower rack 112 disposed under the upper rack 111. The upper rack 111 is spaced a predetermined distance from the lower rack 112.

The racks 11 may be pulled forward out of the washing chamber 10 along guide rails (not shown) disposed on inner side surfaces of the washing chamber 10, or be pushed into the washing chamber 10 along the guide rails.

A nozzle device 12 is disposed in the washing chamber 10 to spray washing water to dishes in the racks 11. The nozzle device 12 includes a lower nozzle 121 for spraying washing water to the lower rack 112, an upper nozzle 122 disposed over the lower nozzle 121 to spray washing water to the upper rack 111, and a top nozzle 123 disposed over the upper nozzle 122 to spray washing water to the upper rack 111. The upper nozzle 122 and the lower nozzle 121 may rotate to uniformly spray the washing water.

A sump 40 is disposed under the washing chamber 10 to collect washing water. The sump 40 includes a washing water storing part, a washing motor, a filter, and a heater.

A washing water guide 124 is connected to the sump 40 to guide washing water to the nozzle device 12. The washing water guide 124 may form a single washing water passage or a plurality of washing water passages. A portion of the washing water guide 124 may be divided to guide washing water to the lower nozzle 121, the upper nozzle 122, and the top nozzle 123.

The washing water guide 124 guides washing water to the upper nozzle 122 and the top nozzle 123. The lower nozzle 121 is connected to a nozzle connection 125 disposed on the top surface of the sump 40, to receive washing water from the sump 40.

A base 4 is disposed under the washing chamber 10 to accommodate a number of parts. The sump 40 may be accommodated in the base 4.

A water supply device 5 is disposed between the washing chamber 10 and the main body 1 to guide washing water, and is configured such that air in the washing chamber 10 communicates with air out of the washing chamber 10. The water supply device 5 maintains the inner space of the washing chamber at the atmospheric pressure, thereby preventing a pressure increase of the inner space due to high temperature air.

A water softener 50 may be installed on the base 4 to soften water. The water softener 50 is connected to the water supply device 5 to soften water supplied by the water supply device 5. The water softener 50 is connected to the sump 40 to supply softened water to the sump 40.

A steaming device 60 is disposed at a side of the sump 40, receives softened water from the water softener 50, and heats the softened water to generate steam.

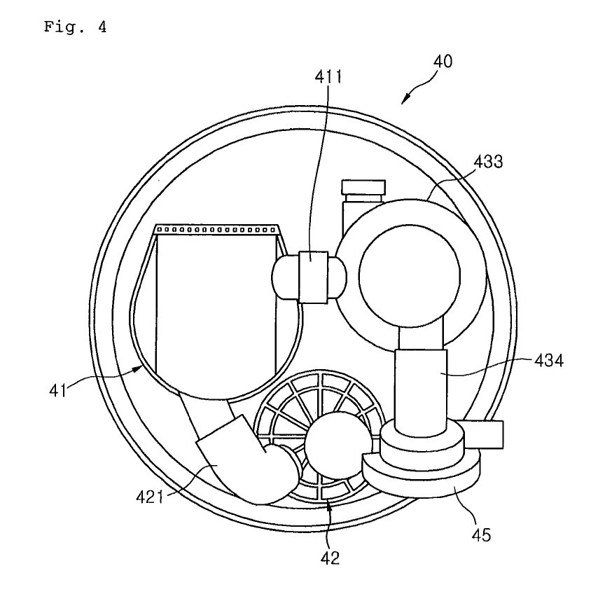

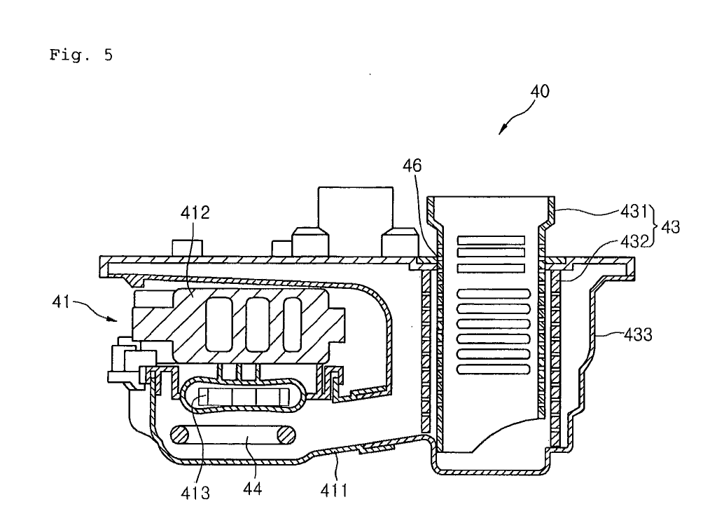

FIG. 4 is a bottom view illustrating a sump according to the first embodiment. FIG. 5 is a cross-sectional view illustrating the sump according to the first embodiment.

Referring to FIGS. 4 and 5, the sump 40 for collecting washing water is disposed under a bottom central portion of the washing chamber 10, that is, in the central portion of the base 4.

The sump 40 has a predetermined inner space in which supplied water is stored. The sump 40 includes: a washing water pump 41 for pumping washing water from the inner space of the sump 40; a passage adjuster 42 for adjusting a passage for the washing water pumped by the washing water pump 41; and a water discharging pump 45 for discharging the washing water and a foreign substance after washing dishes.

Further, the sump 40 includes: a first guide pipe 411 for guiding washing water to the washing water pump 41; a second guide pipe 434 for guiding washing water to the water discharging pump 45′; a filter device 43 for collecting a foreign substance from dishes washed in the washing chamber 10; and an accommodating part 433 for accommodating the filter device 43.

The first guide pipe 411 extends from the accommodating part 433 to the washing water pump 41 to guide washing water to the washing water pump 41 after a foreign substance is filtered off from the washing water. The washing water introduced to the washing water pump 41 can be supplied to the washing chamber 10.

The second guide pipe 434 extends from the accommodating part 433 to the water discharging pump 45 to guide washing water and a foreign substance filtered by the filter device 43, to the water discharging pump 45. The washing water and the foreign substance introduced to the water discharging pump 45 can be discharged out of the dishwasher.

The sump 40 further includes a third guide pipe 421 that guides washing water pumped by the washing water pump 41, to the passage adjuster 42.

The top surface of the sump 40 is provided with an introducing part 46 for introducing washing water into the sump 40. Washing water flows to the filter device 43 through the introducing part 46.

The filter device 43 includes a first filter 431 for filtering a large foreign substance, and a second filter 432 for filtering a small foreign substance. When the washing water pump 41 operates, washing water sequentially passes through the first and second filters 431 and 432, and then, is guided to the washing water pump 41 by the first guide pipe 411.

The washing water pump 41 includes a washing water motor 412 for generating driving force with external power, and an impeller 413 rotated by the driving force generated by the washing water motor 412. When the impeller 413 rotates to generate suction force, washing water is introduced to the washing water pump 41 through the first guide pipe 411.

A sump heater 44 is disposed under the impeller 413 to heat the washing water moved by the suction force of the washing water pump 41. The washing water heated by the sump heater 44 may be used for a hot water washing operation or a hot water rinsing operation of the dishwasher. The washing water heated by the sump heater 44 is moved to the passage adjuster 42 by the driving force of the washing water pump 41.

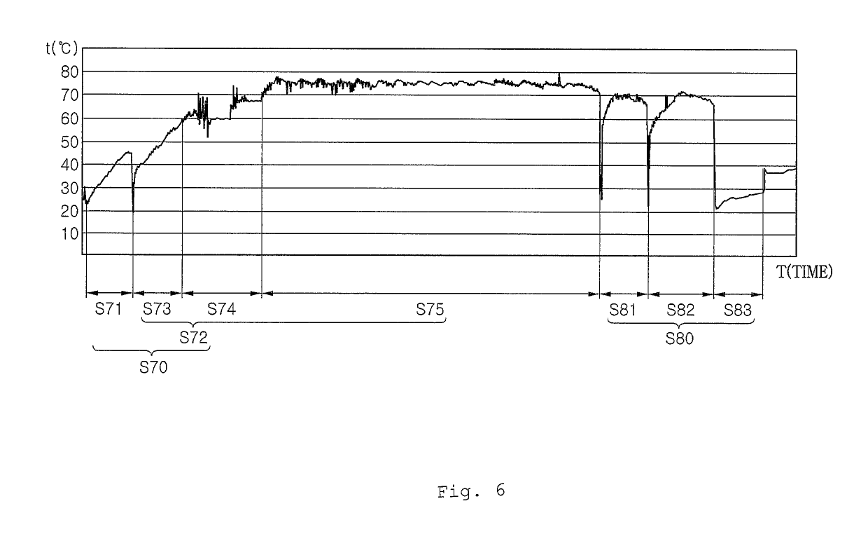

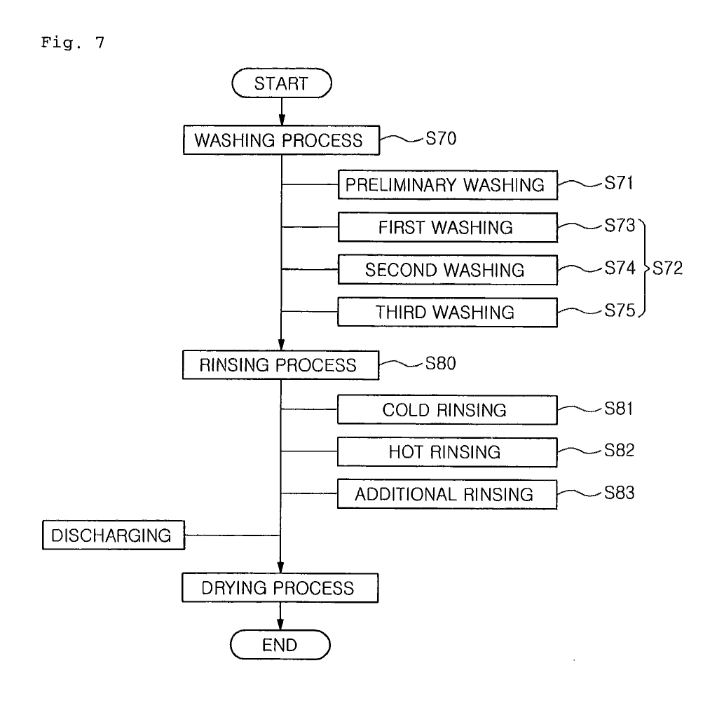

FIG. 6 is a graph illustrating a temperature variation of washing water with time according to processes of the dishwasher according to the first embodiment. FIG. 7 is a flowchart illustrating a method of controlling the dishwasher according to the first embodiment.

Referring to FIGS. 6 and 7, the dishwasher includes the control part to control processes of washing dishes.

The processes may include a washing process S70 in which a dish is washed, a rinsing process S80 in which a dish is rinsed, and a drying process in which a dish is dried after the rinsing process S80.

The washing process S70 may be a single operation, or may include a plurality of operations. Herein, the washing process S70 includes a plurality of operations.

The washing process S70 includes a preliminary washing operation S71 and a plurality of main washing operations S72.

In the preliminary washing operation S71, the sump heater 44 may not be operated, and washing water may be supplied to the nozzle device 12 to preliminarily wash a dish, thereby removing a contaminant or foreign substance from the surface of the dish.

Before the preliminary washing operation S71, water is introduced to the water softener 50, and is softened. The softened water is supplied to the sump 40. At this point, the temperature of the softened water supplied to the sump 40 is increased up to a predetermined temperature according to an inner pressure of the sump 40.

For example, referring to FIG. 6, in the preliminary washing operation S71, the temperature of washing water may be increased up to about 40° C. or higher according to an inner pressure of the sump 40. However, the temperature of washing water is not limited thereto.

After the preliminary washing operation S71, the main washing operations S72 are performed. The main washing operations S72 include a plurality of operations. For example, the main washing operations S72 may include at least a first main washing operation S73, a second main washing operation S74, and, a third main washing operation S75. As a matter of course, the number of the main washing operations S72 is not limited thereto, and thus, may be varied according to characteristics and purposes of the dishwasher.

In the first main washing operation S73, the sump heater 44 is operated to heat washing water accommodated in the sump 40 up to about 60° C. This is because a detergent used in the main washing operations S72 is activated in a range from about 50° C. to about 60° C. However, the temperature of heated washing water is not limited to 60° C., and thus, may be varied according to components and characteristics of a detergent, and the type of a foreign substance attached to a dish.

In the first main washing operation S73, the washing water heated up to about 60° C. by the sump heater 44 is supplied to the nozzle device 12, and is sprayed to the inner space of the washing chamber 10. At this point, a detergent stored in the detergent storage is used, and the detergent and the washing water remove a foreign substance from the dish.

After the first main washing operation S73, the second main washing operation S74 is performed. In the second main washing operation S74, a foreign substance may be removed from the dish by steam generated by the steaming device 60.

In detail, a foreign substance attached to the dish is swollen by the hot water and the detergent in the first main washing operation S73, and the swollen foreign substance is dissolved by high temperature steam in the second main washing operation S74, or its adhering force to the dish may be decreased. As such, the steam facilitates removal of a foreign substance in an operation following the second main washing operation S74. The high temperature steam may directly remove a foreign substance from the dish.

After the second main washing operation S74, the third main washing operation S75 is performed. In the third main washing operation S75, washing water is heated up to about 70° C. or higher by the sump heater 44, and is sprayed into the washing chamber 10 through the nozzle device 12.

Accordingly, a foreign substance dissolved during the second main washing operation S74, a contaminant attached to the dish, or a stain formed on the dish may be removed. The third main washing operation S75 may be repeated for a set time to remove a foreign substance from the dish.

After the third main washing operation S75, the rinsing process S80 is performed. At this point, additional washing water for the rinsing process S80 may be supplied.

In detail, the washing water used to generate the high temperature water and the steam in the main washing operations S72 may be evaporated, and thus, its amount is reduced. Thus, additional washing water may be supplied from the water softener 50 before the rinsing process S80.

The rinsing process S80 includes: a first rinsing operation S81 in which the sump heater 44 is not operated, and washing water is sprayed into the washing chamber 10 through the nozzle device 12 to wash the dish; a second rinsing operation S82 in which the sump heater 44 is operated to heat washing water, and the heated washing water washes the dish; and a third rinsing operation S83 in which the sump heater 44 is not operated, and washing water is supplied to the washing chamber 10 to wash the dish.

In the first rinsing operation S81, washing water supplied to the sump 40 is sprayed into the washing chamber 10 to remove a detergent and a foreign substance remaining on the dish after the washing process S70.

Since washing water is not heated by the sump heater in the first rinsing operation S81, the first rinsing operation S81 may be referred to as a cold rinsing operation. Cold water used in the cold rinsing operation S81 contacts the dish heated during the washing process S70, and exchanges heat with high temperature air in the washing chamber 10. Thus, the temperature of the cold water is increased up to a certain temperature. In this case, the cold water is washing water that is not heated by the sump heater 44, and is not typical cold water.

After the first rinsing operation S81, the second rinsing operation S82 is performed. Since washing water is heated by the sump heater 44 in the second rinsing operation S82, the second rinsing operation S82 may be referred to as a hot rinsing operation. In the second rinsing operation S82, the dish is additionally rinsed, and a temperature required in the drying operation is obtained.

After the second rinsing operation S82, the third rinsing operation S83 is performed. Since the sump heater 44 is not operated in the third rinsing operation S83, the sump heater can be cooled. Since the third rinsing operation S83 is additionally performed after the hot rinsing operation, the third rinsing operation S83 may be referred to as an additional rinsing operation.

That is, after the hot rinsing operation S82, the additional rinsing operation S83 is performed before a discharging operation in which used washing water is discharged.

Since the sump heater 44 is substantially not operated in the third rinsing operation S83, the sump heater 44 can be cooled in the third rinsing operation S83.

In detail, in the discharging operation, the washing water is discharged out of the main body 1, and the inner space of the sump 40, for example, a space accommodating the sump heater 44 momentarily reaches a high pressure and high temperature condition. Accordingly, the sump heater 44 may be excessively heated.

However, since the sump heater 44 is cooled in the third rinsing operation S83, a pressure increase of the space accommodating the sump heater 44, and a damage of the sump heater 44 due to remaining heat can be prevented.

After the rinsing process S80, the discharging operation and the drying process are performed. In the drying process, washing water is not supplied, and moisture in the washing chamber 10 is condensed or discharged, thereby drying the dish. According to the present disclosure, various methods of drying a dish may be used.

Hereinafter, a description will be made according to a second embodiment. Here, different parts between the first and second embodiments will be described principally, and a description of the same parts thereof will be omitted, and like reference numerals denote like elements throughout.

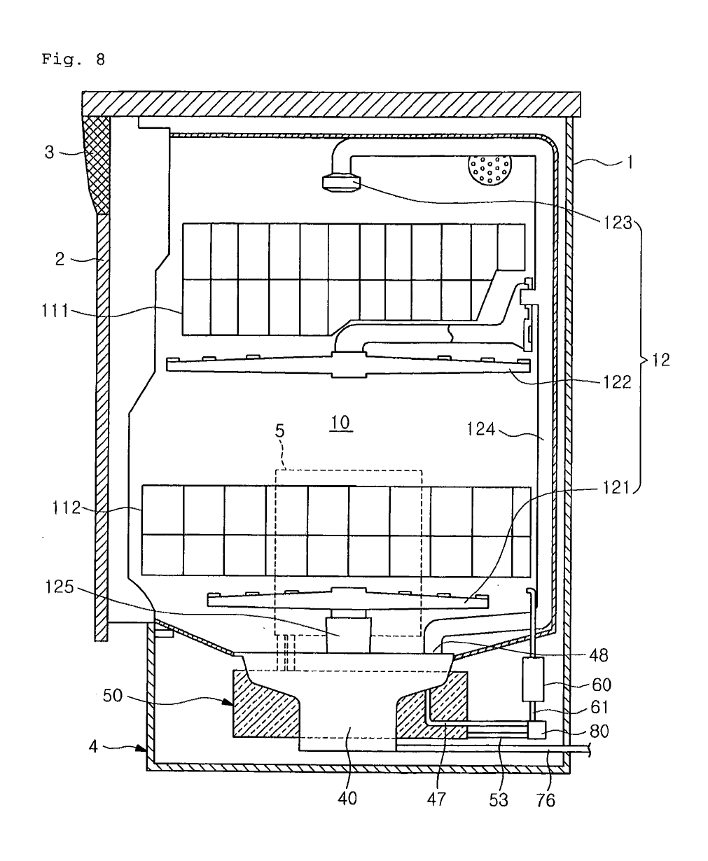

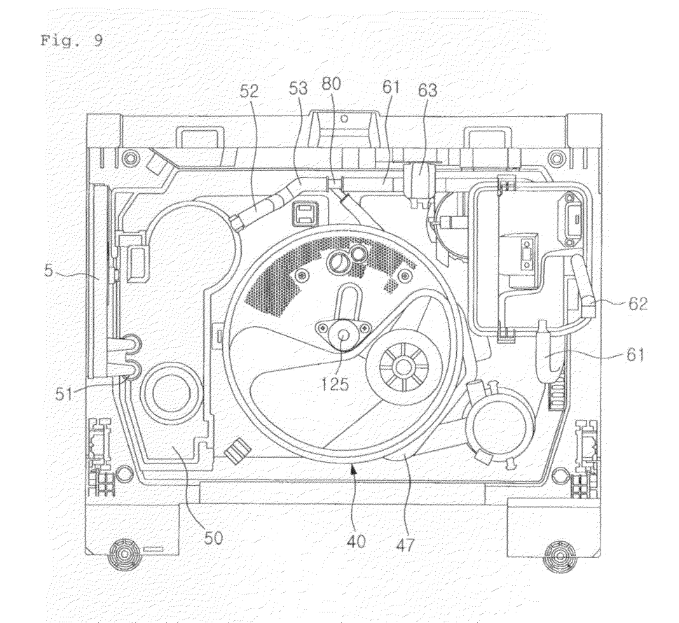

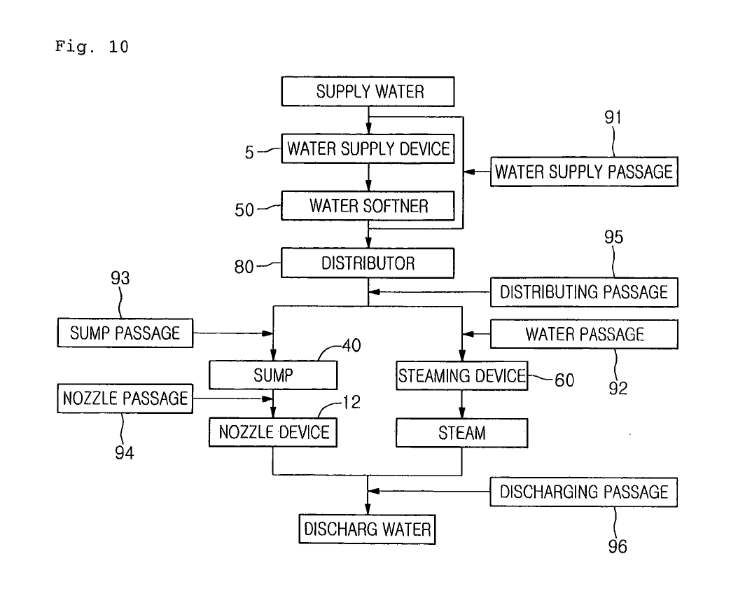

FIG. 8 is a cross-sectional view illustrating a dishwasher according to the second embodiment. FIG. 9 is a plan view illustrating a state in which a washing chamber is removed from the dishwasher, according to the second embodiment. FIG. 10 is a block diagram illustrating passages of the dishwasher according to the second embodiment.

Referring to FIGS. 8 to 10, the water softener 50 is installed on the base 4 to soften supplied water. Soft water contains very low levels of calcium ions and magnesium ions, so that it lathers easily with a detergent and does not cause scale, which is also called a white film.

The water softener 50 has a predetermined inner space accommodating an ionized resin to soften water.

In detail, the water softener 50 includes an introducing part 51 for introducing water, and a discharging part 52 for discharging softened water. The introducing part 51 is connected to the water supply device 5 for controlling a flow rate of supplied water. The discharging part 52 is connected to a soft water guide pipe 53 for guiding water softened by the water softener 50.

The water supply device 5 is disposed between an inner surface of the main body 1 and an outer surface of the washing chamber 10, and includes a flowmeter to control a flow rate of water supplied to the main body 1. That is, a flow rate of water supplied to the water softener 50 is controlled by the water supply device 5, thus preventing an overflow from the water softener 50, and a backflow from the water softener 50 to the water supply device 5. For example, when the amount of water supplied to the water softener 50 is greater than a capacity of the water softener 50, the water supply device 5 limits a supply of water, thereby preventing water from being supplied to the water softener 50.

The sump 40 disposed at a side of the water softener 50 stores a portion of water softened by the water softener 50.

The sump 40 includes a sump introduction part 47 providing a passage for introducing soft water from the water softener 50 into the sump 40; and a sump discharge part 48 for discharging water from the sump 40 to the washing water guide 124. A sump introduction control part may be disposed at a side of the sump introduction part 47 to control a flow rate of water introduced to the sump 40.

The sump 40 is connected to a discharging pipe 76 that discharges washing water and a foreign substance out of the main body 1 after a dish is washed in the washing chamber 10. The discharging pipe 76 extends from the water discharging pump 45 to the outside of the sump 40.

The steaming device 60 may be disposed at a side of the sump 40 to receive and heat water softened by the water softener 50 to generate steam.

A steam heater is disposed in the steaming device 60 to heat water. The steam heater receives power to heat water accommodated in the steaming device 60 and generate steam. A steam introducing part may be disposed on an inner surface of the washing chamber 10 to introduce steam from the steaming device 60 into the washing chamber 10.

A water supply pipe 61 is connected to an inlet of the steaming device 60 to supply soft water from the water softener 50 into the steaming device 60. A steam discharging pipe 62 is connected to an outlet of the steaming device 60 to discharging steam from the steaming device 60 to the steam introducing part.

The water softener 50 may be connected directly to the sump 40 and the steaming device 60 to supply soft water for washing water and steam, or the soft water guide pipe 53 may be connected to a distributor 80 to be described later, to distribute soft water from the water softener 50 to the sump 40 and the steaming device 60.

In the current embodiment, the soft water guide pipe 53 is connected to the distributor 80, and the distributor 80 is connected to the sump 40 and the steaming device 60.

The soft water guide pipe 53 has a pipe shape with a predetermined diameter, and guides soft water from the water softener 50 to the distributor 80.

An inlet of the distributor 80 is connected to the soft water guide pipe 53, and its outlets are connected to the sump 40 and the steaming device 60, respectively. That is, soft water introduced through the soft water guide pipe 53 is distributed in two directions to the sump 40 and the steaming device 60 by the distributor 80.

One of the outlets of the distributor 80 is connected to the sump introduction part 47, and the other is connected to the water supply pipe 61. Soft water introduced through the sump introduction part 47 is used as washing water. Soft water introduced through the water supply pipe 61 is used as water for steam. The distributor 80 may include a two-way valve to control a flow rate of water.

The sump introduction part 47 may be provided with a sump flow control part for controlling a flow rate of soft water introduced through the soft water guide pipe 53. The water supply pipe 61 may be provided with a water control part 63 for controlling a flow rate of soft water introduced through the soft water guide pipe 53.

Referring to FIG. 10, the passages will now be described according to the current embodiment.

The passages of the dishwasher include a water supply passage 91 for guiding supplied water to the water softener 50, a water passage 92 for guiding a portion of soft water from the water softener 50 to the steaming device 60, a sump passage 93 for guiding the other portion of the soft water from the water softener 50 to the sump 40, and a nozzle passage 94 for guiding water from the sump 40 to the nozzle device 12.

Further, the passages include a distributing passage 95 that is disposed between the water softener 50 and the water passage 92 between the water softener 50 and the sump passage 93 to distribute soft water from the water softener 50 to the water passage 92 and the sump passage 93.

The passages further include a discharging passage 96 in which the discharging pipe 76 guides washing water and steam to be discharged out of the main body 1 after washing a dish.

The distributing passage 95 is formed by the distributor 80. The distributing passage 95 includes a first distributing passage connecting one of the outlets of the distributor 80 to the water passage 92, and a second distributing passage connecting the other of the outlets of the distributor 80 to the sump passage 93.

Operations of the dishwasher configured as described above will now be described with respect to a water flow.

When the power switch 31 is manipulated to apply power to the main body 1, the water supply device 5 controls a flow rate of supplied water.

When the water is supplied from the water supply device 5 to the water softener 50, the water is guided along the water supply passage 91, and is supplied to the water softener 50. A passage for supplying introduced water to the water softener 50 through the water supply device 5 is referred to as the water supply passage 91.

The water supplied to the water softener 50 is softened by the water softener 50. The softened water is guided by the soft water guide pipe 53, and is moved to the distributor 80.

At least one portion of the softened water moved to the distributor 80 is guided along the distributing passage 95 and the water passage 92, and is supplied as steam water for generating steam, to the steaming device 60. At this point, a flow rate of the steam water may be controlled by the water control part 63.

The other portion of the softened water moved to the distributor 80 is guided along the distributing passage 95 and the sump passage 93, and is supplied as washing water to the sump 40. At this point, a flow rate of the washing water may be controlled by the sump flow control part.

The washing water supplied to the sump 40 is supplied to the nozzle device 12 along the nozzle passage 94. The washing water supplied to the nozzle device 12 is sprayed into the washing chamber 10 to wash a dish, and then, is recovered to the sump 40, and the filter device 43 filters a foreign substance from the washing water.

The steam supplied from the steaming device 60 into the washing chamber 10, and the washing water sprayed from the nozzle device 12 into the washing chamber 10 are recovered in a liquid state to the sump 40. After a washing process, the recovered water (contaminated water) is guided along the discharging passage 96, and is discharged out of the main body 1.

Hereinafter, a description will be made according to a third embodiment. Different parts of the current embodiment from those of the first and second embodiments will be described principally, and a description of the same parts thereof will be omitted, and like reference numerals denote like elements throughout.

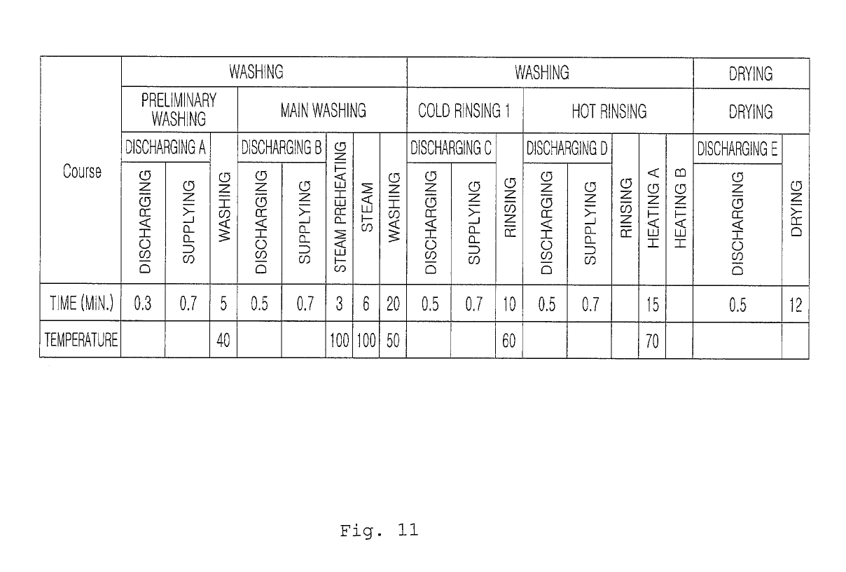

FIG. 11 is a table illustrating process conditions of a dishwasher according to the third embodiment.

Referring to FIG. 11, the dishwasher performs a plurality of processes to wash a dish. The processes includes a washing process in which a dish is washed, a rinsing process in which a dish is dried, and a drying process in which a dish is dried.

The manipulation part 32 of the control panel 3 is manipulated by a user to wash a specifically purposed container having a specific shape. The manipulation part 32 includes a button for selecting a container washing course adapted for the container.

For example, the container may be a wine glass. The wine glass includes a bottom and a round bowl, and should be efficiently washed and dried. That is, the gloss of the wine glass should be maintained, and the wine glass should be protected from a scratch. To this end, effective washing and drying processes of the dishwasher will now be described.

When the container washing course is selected by the user, the control panel 3 controls the main body 1 to sequentially perform a washing process, a rinsing process, and a drying process. A water discharging operation may be performed in an initial stage of each process, so that the process cannot be affected by the temperature of washing water and humidity of the washing chamber 10 in a previous process.

The washing process is divided into a preliminary washing operation and a main washing operation. The preliminary washing operation includes a discharging operation and a washing operation. In the discharging operation, used washing water is discharged from the sump 40, and then, new water is supplied. The discharging operation is performed for about 1 minute (water is discharged for about 20 seconds, and water is supplied for about 43 seconds).

After the discharging operation, the washing operation of the preliminary washing operation is performed. In the washing operation, the container is washed with washing water of about 40° C. for about 5 minutes.

After the washing operation of the preliminary washing operation, the main washing operation is performed. In the main washing operation, a discharging operation, a steam pre-heating operation, a steaming operation, and a washing operation are sequentially performed.

In the discharging operation of the main washing operation, the washing water used in the preliminary washing operation is discharged out of the main body 1. The discharging operation of the main washing operation is performed for about 10 more seconds (water is discharged for about 30 seconds, and water is supplied for about 43 seconds) than the discharging operation of the preliminary washing operation.

In the steam pre-heating operation of the main washing operation, water supplied to the steaming device 60 is heated to about 100° C. or higher to generate steam. At this point, the steam heater disposed in the steaming device 60 is operated for about 3 minutes to heat the supplied water.

When the steam is generated in the steam pre-heating operation, the steaming device 60 performs the steaming operation in which the steam is supplied into the washing chamber 10 through a steam supply part. After the steaming operation, the washing operation of the main washing operation is performed.

The washing operation of the main washing operation is performed with washing water of about 50° C. for about 20 minutes, and the washing water is sprayed into the washing chamber 10 through the nozzle device 12. When the washing operation of the main washing operation is completed, the main washing operation and the washing process are ended.

In the washing operation of the preliminary washing operation or the main washing operation, the upper nozzle 122 and the lower nozzle 121 may operate sequentially or alternately. Accordingly, a specifically shaped container such as the wine glass can be efficiently washed.

After the washing process, the rinsing process is performed. The rinsing process includes a cold rinsing operation and a hot rinsing operation.

The cold rinsing operation includes a discharging operation and a rinsing operation. In the discharging operation, the washing water used in the washing process is discharged out of the main body 1, and then, water is supplied.

After the discharging operation, the rinsing operation is performed with washing water of about 60° C. The washing chamber 10 and the dish, which are heated in the washing process, heat the washing water to about 60° C.

After the rinsing operation of the cold rinsing operation, the hot rinsing operation is performed. The hot rinsing operation includes a discharging operation in which the washing water used in the cold rinsing operation is discharged. In addition, in the discharging operation of the hot rinsing operation, water is supplied. After that, a rinsing operation is performed with unheated washing water. After that, a heating operation in which washing water is heated is performed.

The heating operation includes a first heating operation and a second heating operation. In the first heating operation, washing water is heated to about 70° C., and is sprayed to the washing chamber 10 for about 15 minutes.

For example, when a wine glass is washed by the dishwasher, the wine glass may be damaged by high temperature washing water. Thus, the temperature of washing water sprayed to the wine glass is limited to about 70° C. In the current embodiment, the temperature of washing water in the washing operation of the main washing operation may be about 50° C., and the temperature of washing water of the first heating operation may be about 70° C.

In the second heating operation, the container is rinsed and washed with the washing water heated in the first heating operation, without heating washing water. The second heating operation is an additional rinsing operation after heating.

After the second heating operation, the drying process is performed. The drying process includes a discharging operation in which the washing water used in the second heating operation is discharged, and a drying operation in which the container is dried after the discharging operation.

In the drying operation, the washing chamber 10 and the container accommodated in the washing chamber 10 are dried, and thus, wiping of the container with a towel is unnecessary. Accordingly, the surface of the container is protected, and its gloss is maintained.

According to the embodiments, after the rinsing process in which a dish is rinsed, before used washing water is discharged, when the sump heater is stopped, the rinsing operation is additionally performed, thereby rinsing the dish more cleanly.

In addition, since the sump heater disposed in the sump is not operated in the rinsing operation, the sump heater is cooled in the rinsing operation, and thus, is protected from a thermal damage, and energy for operating the sump heater can be saved.

In addition, since the dishwasher includes the water softener to supply soft water to the steaming device and the sump, scale (calcium) is prevented from being formed on the steaming device and the sump, thereby increasing the service life of the steaming device and the sump.

In addition, since scale (calcium) is prevented from being formed on the steaming device, overheat of the steam heater is prevented, and thus, breakage or breakdown of the steam heater can be prevented.

As a result, since soft water is used as washing water or water for steam, a dish can be washed more efficiently, and formation of a contaminant due to supplied water can be prevented.

In addition, since steam is used to wash a specifically purposed container having a specific shape, the container is washed more efficiently, and its gloss is improved.

In addition, since the drying process is performed after the rinsing process, a damage to the surface of a container can be reduced.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A dishwasher comprising:
a washing space including a rack accommodating a dish, and a nozzle for spraying washing water;
a sump collecting the washing water supplied to the washing space;
a water supply device supplying the washing water to the sump;
a heater disposed in the sump and heating the washing water; and
a control part controlling a washing process in which washing water including a detergent is sprayed toward the dish, and a rinsing process in which the dish is rinsed after the washing process,
wherein the rinsing process includes:
a first rinsing operation in which the washing water stored in the sump is sprayed to the nozzle after the washing process;
a second rinsing operation in which the washing water heated by the heater is sprayed through the nozzle after the first rinsing operation; and
a third rinsing operation in which the washing water stored in the sump is sprayed through the nozzle after the second rinsing operation.

2. The dishwasher according to claim 1, wherein the heater is turned off in at least one of the first rinsing operation and the third rinsing operation.

3. The dishwasher according to claim 1, further comprising a discharging process in which the washing water stored in the sump is discharged,
wherein the third rinsing operation is performed before the discharging process.

4. The dishwasher according to claim 1, further comprising a steaming device provided with a steam heater for generating steam from the washing water supplied by the water supply device.

5. The dishwasher according to claim 1, wherein the washing process comprises:
a preliminary washing operation in which the washing water is supplied to the nozzle without heating the washing water; and
at least one main washing operation in which the washing water heated by the heater is supplied to the nozzle.

6. The dishwasher according to claim 5, wherein the main washing operation comprises:
a first main washing operation in which the washing water heated by the heater is supplied to the washing space;
a second main washing operation in which the steam generated by the steam heater is supplied to the washing space; and
a third main washing operation in which the washing water heated by the heater is supplied to the washing space after the second main washing operation.

7. The dishwasher according to claim 4, further comprising:
a main body forming an appearance of the dishwasher;
a washing chamber disposed in the main body to provide a washing space for a dish; and
a water softener disposed in the main body to soften supplied water.

8. The dishwasher according to claim 7, further comprising a distributor for distributing the water softened by the water softener, to the steaming device and the sump.

9. The dishwasher according to claim 7, wherein the distributor comprises a two-way valve.

10. The dishwasher according to claim 8, further comprising a flow control part controlling an amount of the softened water distributed to the steaming device or the sump by the distributor.

11. The dishwasher according to claim 7, wherein the water softener is disposed at an outlet of the water supply device, and
the water supply device controls a flow rate of water supplied to the water softener to prevent an overflow from the water softener or a backflow from the water softener to the water supply device.

12. The dishwasher according to claim 1, further comprising:
an input part configured to select a container washing course for washing a specific container; and
and an upper nozzle and a lower nozzle that are disposed in an upper portion and a lower portion of the washing space, respectively,
wherein, when the container washing course is selected, the upper and lower nozzles alternately or sequentially operate.

13. The dishwasher according to claim 12, wherein the container washing course comprises:
a washing process including a preliminary washing operation and a main washing operation using steam;
a rinsing process including a cold rinsing operation using washing water, and a hot rinsing operation using heated washing water; and
a drying process for drying the container.

14. The dishwasher according to claim 13, wherein the main washing operation comprises:
a steam pre-heating operation in which steam is generated; and
a steam spraying operation in which the generated steam is sprayed.

15. The dishwasher according to claim 13, wherein the hot rinsing operation comprises:
a first heating operation in which washing water for rinsing the container is heated up to a set temperature to rinse the container; and
a second heating operation in which the container is rinsed with the washing water heated in the first heating operation.

16. A dishwasher comprising:
a washing chamber forming an accommodation space for a dish;
a sump disposed under the washing chamber and including a washing water pump that is selectively driven according to a washing process or a rinsing process;
a water supply device for supplying washing water circulating through the washing chamber and the sump;
a water softener including an ionized resin to soften the washing water supplied by the water supply device;
a steaming device for generating steam from the washing water softened by the water softener; and
a nozzle device for spraying soft water from the sump into the washing chamber,
wherein the rinsing process includes:
a hot rinsing operation in which the soft water is heated to supply the washing chamber; and
a cold rinsing operation in which the soft water is additionally supplied to the washing chamber after the hot rinsing operation before discharging the soft water from the sump.

17. The dishwasher according to claim 16, further comprising a sump heater provided to the sump and heating the soft water circulating through the sump,
wherein the sump heater is turned on in the hot rinsing operation, and is turned off in the cold rinsing operation.

18. The dishwasher according to claim 16, further comprising:
a water supply passage guiding the washing water from the water supply device to the water softener;
a water passage guiding at least one portion of water softened by the water softener to the steaming device;
a sump passage guiding the other portion of the softened water to the sump; and
a nozzle passage guiding the softened water from the sump to the nozzle device.

19. The dishwasher according to claim 18, further comprising a distributing passage for distributing the water softened by the water softener, to the water passage and the sump passage.

20. The dishwasher according to claim 16, wherein the washing process includes a steam pre-heating operation in which steam is generated, and a steam spraying operation in which the generated steam is sprayed to the washing chamber, and
the rinsing process includes a first heating operation in which soft water heated by a steam heater is sprayed to the washing chamber, and a second heating operation in which a dish is washed with the soft water heated in the first heating operation when the steam heater is turned off.
